(19) United States
(12) Patent Application Publication
(10) Pub. No.: US 2022/0010928 A1
(43) Pub. Date: Jan. 13, 2022

(54) HIGH PRESSURE TANK

(71) Applicant: TOYOTA JIDOSHA KABUSHIKI KAISHA, Toyota-shi (JP)

(72) Inventor: Koji KATANO, Toyota-shi (JP)

(73) Assignee: TOYOTA JIDOSHA KABUSHIKI KAISHA, Toyota-shi (JP)

(21) Appl. No.: 17/367,749

(22) Filed: Jul. 6, 2021

(30) Foreign Application Priority Data
Jul. 8, 2020 (JP) 2020-117511

(51) Int. Cl. F17C 1/04

(52) U.S. Cl. CPC F17C 1/04; F17C 2203/0604; F17C 2203/012; F17C 2203/0624; F17C 2270/0184; F17C 2209/2163; F17C 2203/0673; F17C 2221/012; F17C 2201/0109

(57) ABSTRACT

A high pressure tank includes a liner that has gas barrier properties and that is made of resin, a reinforcing layer disposed around the liner, and a cap that is provided on one end of the liner and that includes a flange portion. The reinforcing layer includes a first reinforcing layer that is disposed between the liner and at least a part of a lower face of the flange portion, the part of the lower face including an outer end of the flange portion.

### CROSS-REFERENCE TO RELATED APPLICATION

This application claims priority to Japanese Patent Application No. 2020-117511 filed on Jul. 8, 2020, incorporated herein by reference in its entirety.

### BACKGROUND

### 1. Technical Field

The present disclosure relates to a high pressure tank.

### 2. Description of Related Art

Japanese Unexamined Patent Application Publication No. 2015-140830 (JP 2015-140830 A) describes a structure of a high pressure tank that has a liner made of resin, a reinforcing layer made of carbon fiber reinforced plastic (CFRP), and a cap made of metal. In this conventional technology, the reinforcing layer is disposed on an outer side of a flange portion of the cap. An outer end of the flange portion of the cap is in contact with two layers of a liner and the reinforcing layer.

### SUMMARY

However, there has been a problem in the structure of the conventional technology, in that when the temperature of the high pressure tank becomes higher, or the internal pressure rises, there is a possibility that the liner portion in contact with the outer end of the flange portion of the cap might become deformed, and the liner might be damaged.

The present disclosure can be realized as the following aspect.

According to an aspect of the present disclosure, a high pressure tank is provided. The high pressure tank includes a liner that has gas barrier properties and that is made of resin, a reinforcing layer disposed around the liner, and a cap that is provided on one end of the liner and that includes a flange portion. The reinforcing layer includes a first reinforcing layer that is disposed between the liner and at least a part of a lower face of the flange portion, the part of the lower face including an outer end of the flange portion. According to this high pressure tank, the first reinforcing layer is disposed between the liner and at least the part of the lower face including the outer end of the flange portion, and accordingly the possibility of the liner being damaged by the outer end of the flange portion of the cap can be reduced.

In the above high pressure tank, the reinforcing layer may further include a second reinforcing layer disposed on an upper face of the flange portion. According to this high pressure tank, sufficient reinforcement can be realized without making the thickness of the first reinforcing layer to be excessively great.

In the above high pressure tank, the reinforcing layer may include a reinforcing pipe portion and a pair of reinforcing dome portions joined to openings at both ends of the reinforcing pipe portion, with each of the reinforcing dome portions including the first reinforcing layer and the second reinforcing layer. According to this high pressure tank, the high pressure tank having the first reinforcing layer and the second reinforcing layer can be easily manufactured.

In the above high pressure tank, the first reinforcing layer may be disposed in contact with the entirety of the lower face of the flange portion. According to this high pressure tank, the possibility of the liner being damaged by the outer end of the flange portion of the cap can be further reduced.

In the above high pressure tank, the cap may have a first opening portion. The liner may have a second opening portion that is smaller in diameter than the first opening portion at a liner portion joined to the cap, and the first opening portion and the second opening portion may configure a part of a channel for communicating between inside of the high pressure tank and outside of the high pressure tank. According to this high pressure tank, the liner and the cap can be strongly joined.

Note that the present disclosure can be realized in various forms, and for example, can be realized in the form of a manufacturing method of a high pressure tank, or the like.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view illustrating a configuration of a high pressure tank according to a first embodiment;

FIG. 2 is an enlarged sectional view illustrating one end of the high pressure tank;

FIG. 3 is an explanatory diagram illustrating deformation of a liner in a comparative example;

FIG. 4 is a flowchart showing a manufacturing method of the high pressure tank;

FIG. 5 is an explanatory diagram illustrating an example of a method of forming a reinforcing pipe portion;

FIG. 6 is an explanatory diagram illustrating an example of a method of forming a reinforcing dome portion;

FIG. 7 is an explanatory diagram illustrating a method of forming an outer helical layer;

FIG. 8 is a sectional view illustrating a configuration of a high pressure tank according to a second embodiment; and

FIG. 9 is a sectional view illustrating a configuration of a high pressure tank according to a third embodiment.

### DETAILED DESCRIPTION OF EMBODIMENTS

### A. First Embodiment

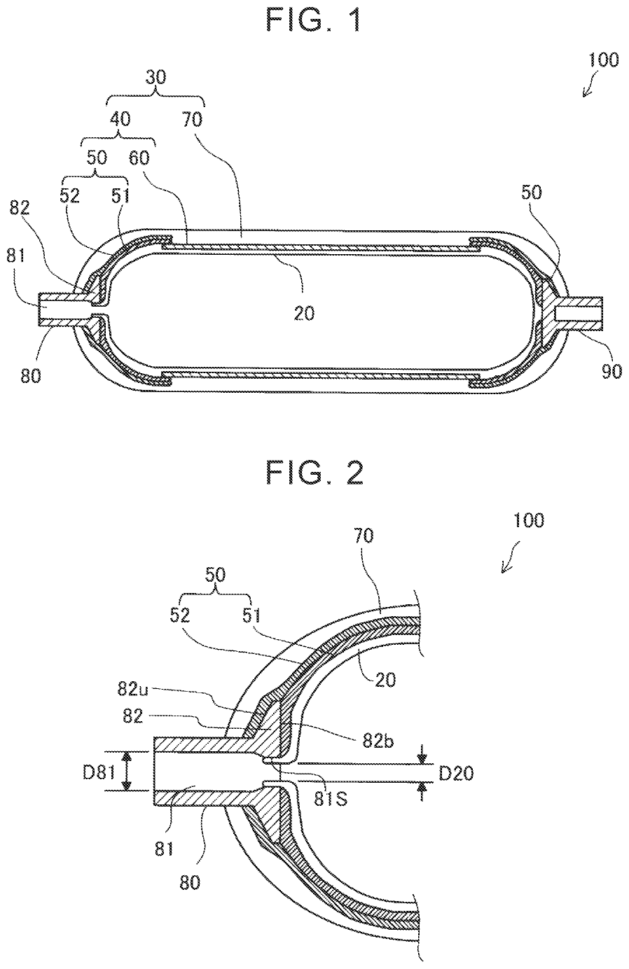

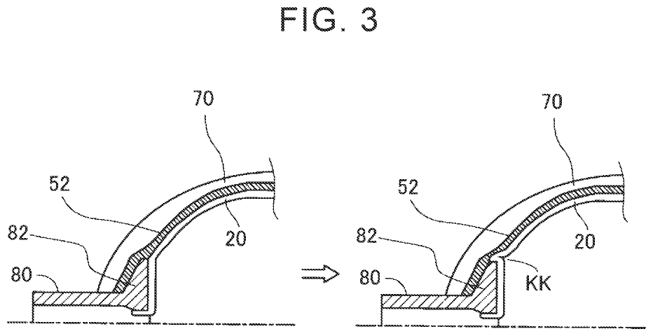

FIG. 1 is a sectional view illustrating a configuration of a high pressure tank 100 according to a first embodiment, and FIG. 2 is an enlarged sectional view illustrating a part thereof. The high pressure tank 100 is a storage container for storing a gas such as hydrogen gas or the like, and is used to store hydrogen to be supplied to a fuel cell for a vehicle or a stationary fuel cell, for example. Generally, high pressure tanks are tanks that store gas at a pressure of 200 kPa or higher in gauge pressure at 20° C. High pressure tanks used for fuel cells typically store hydrogen at a pressure of 30 MPa or higher in gauge pressure at 20° C.

The high pressure tank 100 is provided with a resin liner 20 that has gas barrier properties, a reinforcing layer 30 disposed around the liner 20, and two caps 80 and 90 disposed at respective end portions of the high pressure tank 100. A first cap 80 has a communicating orifice 81 for communicating between the space inside the liner 20 and the external space, and a flange portion 82. A connecting device including a valve is provided in the communicating orifice 81. The flange portion 82 is a portion extending in a substantially disc-like form at the base of the cap 80. The flange portion 82 has an upper face 82u and a lower face 82b, as illustrated in FIG. 2. The upper face 82u of the flange portion 82 is the face of the flange portion 82 that is farther away from the middle of the high pressure tank 100 in the longitudinal direction thereof, and the lower face 82b of the flange portion 82 is the face of the flange portion 82 that is closer to the middle of the high pressure tank 100 in the longitudinal direction thereof. In the present embodiment, the lower face 82b of the flange portion 82 constitutes the lower face of the entire cap 80. The second cap 90 does not have a communicating orifice communicating with the external space, but may be provided with a communicating orifice. Alternatively, the second cap 90 may be omitted.

The liner 20 is made of a resin having gas barrier properties for suppressing transmission of the gas to the outside. Examples of resin that can be used to form the liner 20 include thermoplastic resins such as polyamide, polyethylene, ethylene vinyl alcohol copolymer resin (EVOH), and polyester, and thermosetting resins such as epoxy.

The reinforcing layer 30 is a fiber-reinforced resin layer that reinforces the liner 20, and has a joined body 40 including reinforcing dome portions 50 and a reinforcing pipe portion 60, and an outer helical layer 70. The reinforcing layer 30 may also be referred to as a “reinforcing body”. The joined body 40 includes the reinforcing pipe portion 60 and the reinforcing dome portions 50 each disposed on either end thereof In the present embodiment, the joined body 40 further includes the caps 80 and 90 joined to the reinforcing dome portions 50.

The reinforcing dome portions 50 each have a first dome portion 51 and a second dome portion 52. The first dome portion 51 and the second dome portion 52 both have domed shapes. More specifically, the first dome portion 51 has a shape in which the external diameter gradually increases from one end thereof toward an opening end at the other end. The “opening end” here is, of both ends of the first dome portion 51, the end portion thereof closer to the center of the high pressure tank 100 along the axial direction of the high pressure tank 100. The end of the first dome portion 51 at the opposite side from the opening end is in contact with the cap 80. Although the first dome portion 51 in the example illustrated in FIG. 1 has a shape obtained by cutting away a part of a substantially spherical shape that is hollow, various other shapes may be employed as well. The second dome portion 52 is configured in the same way. Apart of the first dome portion 51 adjacent to the flange portion 82 is disposed between the lower face 82b of the flange portion 82 and the liner 20. As illustrated in FIG. 2, the first dome portion 51 is disposed so as to be in contact with the entirety of the lower face 82b of the flange portion 82 in the present embodiment. Note however, that the first dome portion 51 may be disposed to come in contact with, out of the lower face 82b of the flange portion 82, only a part of the lower face portion of the flange portion 82, the part of the lower face portion including the outer end of the flange portion 82. The part of the second dome portion 52 adjacent to the flange portion 82 is disposed so as to be in contact with the upper face 82u of the flange portion 82. Also, the first dome portion 51 and the second dome portion 52 are joined to each other at a portion further to the outer side than the outer end of the flange portion 82. The first dome portion 51 corresponds to a “first reinforcing layer” of the present disclosure, and the second dome portion 52 corresponds to a “second reinforcing layer” of the present disclosure. A method of forming the reinforcing dome portions 50 will be described later.

The reinforcing pipe portion 60 has a straight pipe shape. A method of forming the reinforcing pipe portion 60 will be described later. The reinforcing dome portions 50 are each joined to the openings at the respective ends of the reinforcing pipe portion 60. In the present embodiment, the reinforcing dome portions 50 are disposed such that the opening ends of the reinforcing dome portions 50 are located on the outer side of the reinforcing pipe portion 60. Note however, that the reinforcing dome portions 50 may be disposed such that the opening ends of the reinforcing dome portions 50 are located on the inner face of the reinforcing pipe portion 60.

The outer helical layer 70 is a layer formed by helical winding to resin-impregnated fiber onto the outer face of the joined body 40 including the reinforcing dome portions 50 and the reinforcing pipe portion 60. The primary function of the outer helical layer 70 is to prevent the reinforcing dome portions 50 from coming loose from the reinforcing pipe portion 60 when the inner pressure of the high pressure tank 100 is raised. Hatching of the outer helical layer 70 and the liner 20 is omitted in FIG. 1, for the sake of convenience of illustration.

Examples of resin that can be used to form the reinforcing layer 30 include thermosetting resin such as phenolic resins, melamine resins, urea-formaldehyde resins, epoxy resins, and so forth, with epoxy resins being preferably used in particular, from the perspective of mechanical strength and so forth. Examples of fibers that can be used to make up the reinforcing layer 30 include glass fibers, aramid fibers, boron fibers, carbon fibers, and so forth. In particular, carbon fibers are preferably used from the perspective of lightness, mechanical strength, and so forth.

As illustrated in FIG. 2, the liner 20 is disposed on the inner face of the reinforcing dome portions 50, i.e., so as to come into contact with the inner face of the first dome portion 51, and further is joined to an inner face 81s of the communicating orifice 81 at the base of the cap 80. Joining the liner 20 to the cap 80 maintains the inside of the liner 20 in an airtight state. An opening portion of the liner 20 has an inner diameter D20 at the joining portion of the liner 20 and the cap 80. On the other hand, the communicating orifice 81 of the cap 80 has an inner diameter D81 at the proximity of the outlet thereof. In the present embodiment, the inner diameter D20 of the liner 20 is set to be smaller than the inner diameter D81 at the proximity of the outlet of the communicating orifice 81 of the cap 80. Thus, the connecting device including the valve can be easily connected to the communicating orifice 81, and also the liner 20 and the cap 80 can be strongly joined. Also, the opening portion of the cap 80 having the inner diameter D81 corresponds to a “first opening portion” of the present disclosure, and the opening portion of the liner 20 having the inner diameter D20 corresponds to a “second opening portion” of the present disclosure. The first opening portion and the second opening portion make up a part of a channel through which the inside of the high pressure tank 100 communicates with the outside of the high pressure tank 100.

FIG. 3 is an explanatory diagram illustrating deformation of the liner 20 in a comparative example. A configuration of a comparative example illustrated to the left side in FIG. 3 has a configuration in which the first dome portion 51 has been omitted from the configuration of the first embodiment illustrated in FIG. 2, with the outer end of the flange portion 82 of the cap 80 being in contact with the two layers of the liner 20 and the second dome portion 52. In this comparative example, when the temperature of the high pressure tank 100 rises and the cap 80 expands or the inner pressure of the tank rises, for example, there is a possibility of the portion of the liner 20 that is in contact with the outer end of the cap 80 deforming and a kink KK being created as illustrated to the right side in FIG. 3, and the liner 20 being damaged. A reason in such trouble occurring is due to the expansion coefficient and the percent elongation differing among the three parts, which are the liner 20, the second dome portion 52, and the cap 80.

On the other hand, the first dome portion 51 is disposed between the lower face 82b of the flange portion 82 and the liner 20 in the configuration according to the first embodiment illustrated in FIG. 2, and accordingly the possibility of the liner 20 being damaged by the outer end of the flange portion 82 of the cap 80 can be reduced. Note that a reinforcing layer that is smaller than the first dome portion 51 may be used as the reinforcing layer disposed between the lower face 82b of the flange portion 82 and the liner 20. For example, an arrangement may be made in which the reinforcing dome portions 50 are configured of the second dome portion 52 alone, using a small reinforcing layer disposed only between the lower face 82b of the flange portion 82 and the liner 20, instead of the first dome portion 51. Note however, that disposing a part of the first dome portion 51 between the lower face 82b of the flange portion 82 and the liner 20 enables the high pressure tank 100 to be manufactured more easily, as in the present embodiment.

In the present embodiment, further, the first dome portion 51 is disposed corning into contact with the entirety of the lower face 82b of the flange portion 82, and accordingly, the possibility of the liner 20 being damaged by the outer end of the flange portion 82 of the cap 80 can be further reduced. Note however, that the first dome portion 51 may be disposed in contact with only a part of the lower face 82b of the flange portion 82. Further, in the present embodiment, the reinforcing dome portions 50 include the second dome portion 52 disposed on the upper face 82u of the flange portion 82, and accordingly, sufficient reinforcement can be performed without excessively increasing the thickness of the first dome portion 51.

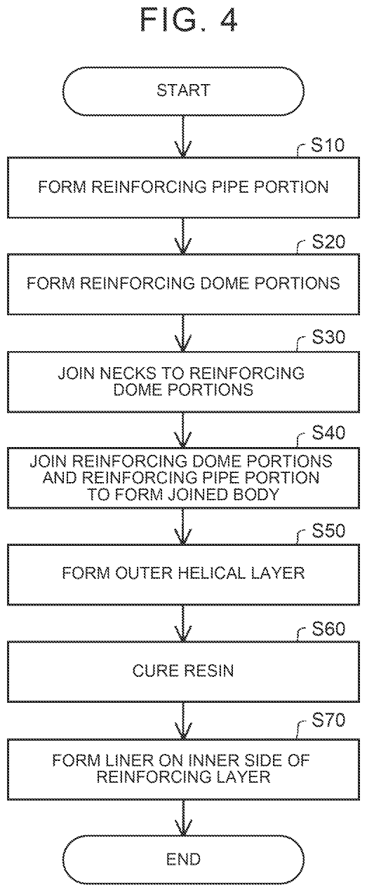

FIG. 4 is a flowchart showing a manufacturing method of the high pressure tank 100. Examples of methods used in the following steps will be described later. In step S10, the reinforcing pipe portion 60 is formed. In step S20, the reinforcing dome portions 50 are formed. In step S30, the caps 80 and 90 are joined to the reinforcing dome portions 50. In step S40, each of the two reinforcing dome portions 50 is joined to an end portion of the reinforcing pipe portion 60 to form the joined body 40. In step S50, the outer helical layer 70 is formed on the outer face of the joined body 40. In step S60, the uncured resin of the reinforcing layer 30 is cured. In step S70, the liner 20 is formed on the inner face of the reinforcing layer 30.

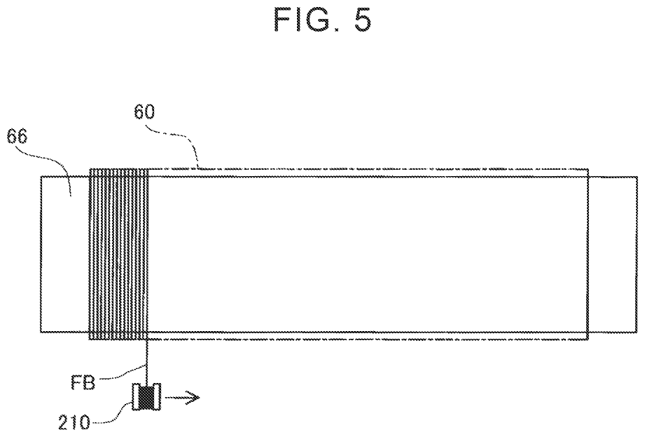

FIG. 5 is an explanatory diagram illustrating an example of a method of forming the reinforcing pipe portion 60 in step S10 of FIG. 4. The reinforcing pipe portion 60 can be formed using filament winding, by winding a fiber bundle FB on a substantially cylindrical mandrel 66. In filament winding, the fiber bundle FB is wound on the mandrel 66 by moving a fiber bundle guide 210 while rotating the mandrel 66. The example in FIG. 5 shows the fiber bundle FB being wound by hoop winding, but helical winding may be used. For the filament winding (FW) method, one of wet FW and dry FW described below can be used.

There generally are the following methods as typical methods for forming objects of fiber-reinforced resin.
Wet FW
Wet FW is a method in which the fiber bundle FB is impregnated with liquid resin of which the viscosity has been lowered, immediately before winding the fiber bundle FB, and the resin-impregnated fiber bundle is wound onto a mandrel.
Dry FW
Dry FW is a method in which a tow prepreg, obtained by impregnating a fiber bundle with resin and then drying in advance, is prepared, and the tow prepreg is wound onto a mandrel.
Resin Transfer Molding (RTM)
RTM is a method of molding in which fiber is set in a pair of male and female molds, the mold is closed, and thereafter resin is poured in from a resin inlet, thereby impregnating the fiber.
Centrifugal Winding (CW)
CW is a method in which a cylindrical member is formed, by applying a fiber sheet on an inner face of a rotating cylindrical mold. For the fiber sheet, a fiber sheet that has been impregnated with resin in advance may be used, or a fiber sheet that has not been impregnated with resin may be used. When employing the latter, resin is poured into the mold after cylindrically winding the fiber sheet, and the fiber sheet is thus impregnated with the resin.

Although filament winding is used to form the reinforcing pipe portion 60 in the example in FIG. 5 described above, the reinforcing pipe portion 60 may be formed using other methods, such as RTM or the like. Curing of the resin of the reinforcing pipe portion 60 may be performed in step S10, or may be performed in step S60.

When performing curing of the resin of the reinforcing pipe portion 60 in step S10, main curing, in which curing is performed completely until the viscosity of the resin is in a stable state at a target value thereof or higher, may be performed. Alternatively, preliminary curing in which main curing is not attained may be performed. Generally, uncured thermosetting resin initially exhibits lower viscosity upon being heated, and when heating is continued thereafter, the viscosity rises. By continuing heating for a sufficient amount of time, the viscosity of the resin is in a stable state at the target value thereof or higher. Assuming such a process, processing in which curing is stopped at any point before reaching the final main curing, which is attained by continuing curing after the viscosity drops and then rises and returns to the initial viscosity, will be referred to as “preliminary curing”. By performing preliminary curing in step S10 and then performing main curing in the later-described step S60, the reinforcing pipe portion 60 can be more powerfully joined to the reinforcing dome portions 50 and the outer helical layer 70.

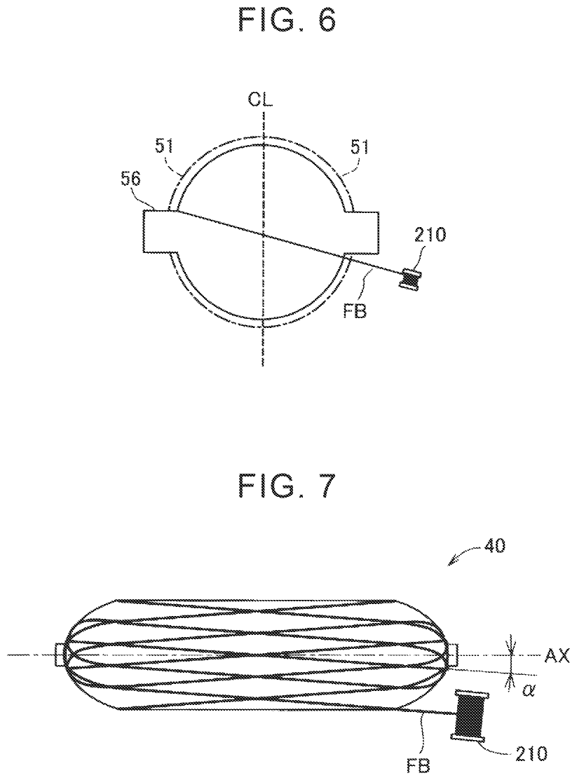

FIG. 6 is an explanatory diagram illustrating an example of a method of forming the first dome portion 51 in step S20 in FIG. 4. The first dome portion 51 can be formed by winding the fiber bundle FB onto a mandrel 56, using filament winding. The mandrel 56 preferably has an external shape of two first dome portions 51 put together. In filament winding, the fiber bundle FB is wound onto the mandrel 56 by moving the fiber bundle guide 210 while rotating the mandrel 56. In the example in FIG. 6, the fiber bundle FB is being wound by helical winding. Either of the above-described wet FW and dry FW may be used for filament winding. After winding of the fiber bundle FB ends, the two first dome portions 51 can be obtained by cutting along a cutting line CL. Note that the first dome portions 51 may be formed using other methods such as RTM or the like. The second dome portion 52 can be formed by approximately the same method as that of the first dome portion 51. Note that the curing of the resin of the first dome portion 51 and the second dome portion 52 may be performed in step S20, or may be performed in step S60.

In step S30 in FIG. 4, the first dome portion 51 and the second dome portion 52 making up the reinforcing dome portions 50, and the caps 80 and 90, are joined. In step S40, the reinforcing pipe portion 60 is further joined to the joined bodies formed in step S30, thereby forming the joined body 40 illustrated in FIG. 1. The joining in steps S30 and S40 may be performed using an adhesive agent or pressure-sensitive adhesive or the like, for example.

FIG. 7 is an explanatory diagram illustrating a method of forming the outer helical layer 70 in step S50 in FIG. 4. The outer helical layer 70 can be formed by winding the fiber bundle FB onto the outer face of the joined body 40 using filament winding. In filament winding, the fiber bundle FB is wound onto the joined body 40 by moving the fiber bundle guide 210 while rotating the joined body 40 about a center axis AX. Either of wet FW or dry FW can be used for filament winding. As described above, the primary function of the outer helical layer 70 is to prevent the reinforcing dome portions 50 from coming loose from the reinforcing pipe portion 60 when the inner pressure of the high pressure tank 100 is raised. In order to achieve this function, a winding angle α of the fiber bundle FB is preferably no greater than 45 degrees. The winding angle α is the angle of the fiber bundle FB as to the center axis AX of the joined body 40.

In step S60 in FIG. 4, uncured resin of the reinforcing layer 30 is cured. This curing is the main curing described with reference to FIG. 5. In step S70, the liner 20 is formed on the inner face of the reinforcing layer 30 following curing. Formation of the liner in step S70 can be performed by putting a liquid liner material inside the reinforcing layer 30 provided with caps, and curing the liner material while rotating the reinforcing layer 30, for example. Thus, when formation of the liner 20 ends, the high pressure tank 100 illustrated in FIG. 1 is complete.

Note that the liner 20 may be formed in a step other than step S70 in FIG. 4. For example, the liner 20 may be formed separately from the reinforcing dome portions 50 and the reinforcing pipe portion 60, with the liner 20 and the two reinforcing dome portions 50 and caps 80 and 90 being joined thereafter in the above-described step S30. Such formation of the liner 20 may be performed by injection molding, for example. At this time, two divided members obtained by dividing the whole liner 20 into two at the general middle may be formed separately by injection molding, and the two divided members removed from the injection-molding molds may be joined to form the liner 20.

As described above, in the present embodiment, the first dome portion 51 serving as the first reinforcing layer is disposed between the lower face 82b of the cap 80 and the liner 20. As a result, the possibility of the liner 20 being damaged by the outer end of the flange portion 82 of the flange portion 82 can be reduced as compared to when no reinforcing layer is disposed between the lower face 82b of the flange portion 82 and the liner 20.

### B. Other Embodiments

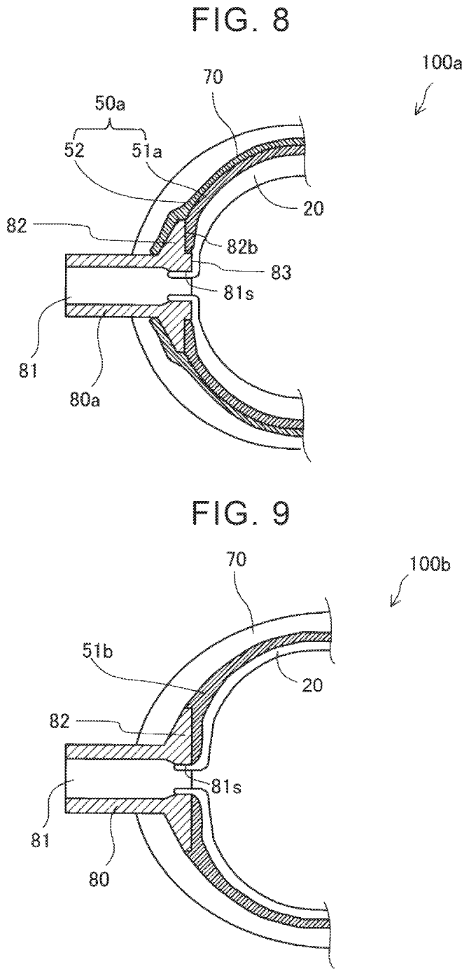

FIG. 8 is a sectional view illustrating a configuration of a high pressure tank 100a according to a second embodiment. This high pressure tank 100a differs from the first embodiment illustrated in FIG. 1 only with regard to the shapes of a cap 80a and a first dome portion 51a of each of reinforcing dome portions 50a, and other configurations are approximately the same as the first embodiment.

The cap 80a has a lower face 83 on the inner side of the lower face 82b of the flange portion 82. The lower face 83 protrudes further toward the middle of the high pressure tank 100a in the longitudinal direction than the lower face 82b of the flange portion 82. Also, the first dome portion 51a is in contact with the entirety of the lower face 82b of the flange portion 82, but is not in contact with the lower face 83. This configuration according to the second embodiment also yields advantages approximately the same as those of the first embodiment.

FIG. 9 is a sectional view illustrating a configuration of a high pressure tank 100b according to a third embodiment. This high pressure tank 100b differs from the first embodiment only with regard to the point that the second dome portion 52 is omitted, and to the shape of a first dome portion 51b, and other configurations are approximately the same as the first embodiment. The second dome portion 52 is omitted in the third embodiment, and accordingly the thickness of the first dome portion 51b is set to be greater than the thickness of the first dome portion 51 according to the first embodiment, in order to secure sufficient reinforcing strength. This configuration according to the third embodiment also yields advantages approximately the same as those of the first embodiment.

The present disclosure is not limited to the above-described embodiment and modifications thereof, and can be realized through various configurations without departing from the essence thereof. For example, the technical features of the embodiment and modifications thereof corresponding to the technical features of the aspects described in the SUMMARY may be substituted or combined as appropriate, in order to solve part or all of the above-described problems, or to achieve part or all of the above-described advantages. The technical features can also be omitted as appropriate, as long as they are not described as being indispensable in the present specification.

What is claimed is:

1. A high pressure tank, comprising:
a liner that has gas barrier properties and that is made of resin;
a reinforcing layer disposed around the liner; and
a cap that is provided on one end of the liner and that includes a flange portion, wherein the reinforcing layer includes a first reinforcing layer that is disposed between the liner and at least a part of a lower face of the flange portion, the part of the lower face including an outer end of the flange portion.

2. The high pressure tank according to claim 1, wherein the reinforcing layer further includes a second reinforcing layer disposed on an upper face of the flange portion.

3. The high pressure tank according to claim 2, wherein:
the reinforcing layer includes a reinforcing pipe portion and a pair of reinforcing dome portions joined to openings at both ends of the reinforcing pipe portion; and
each of the reinforcing dome portions includes the first reinforcing layer and the second reinforcing layer.

4. The high pressure tank according to claim 1, wherein the first reinforcing layer is disposed in contact with the entirety of the lower face of the flange portion.

5. The high pressure tank according to claim 1, wherein:
the cap has a first opening portion;
the liner has a second opening portion that is smaller in diameter than the first opening portion at a liner portion joined to the cap; and
the first opening portion and the second opening portion constitute a part of a channel for communicating between inside of the high pressure tank and outside of the high pressure tank.
